(19) United States
(12) Patent Application Publication
(10) Pub. No.: US 2005/0144612 A1
(43) Pub. Date: Jun. 30, 2005

(54) Firmware updating method and application utilizing the same

(76) Inventors: Shin-Ping Wang, Pingtung County (TW); Sheng Lai, Taipei County (TW)

Correspondence Address: BIRCH STEWART KOLASCH & BIRCH, PO BOX 747, FALLS CHURCH, VA, 22040-0747, US

(21) Appl. No.: 10/921,132

(22) Filed: Aug. 19, 2004

(30) Foreign Application Priority Data
Dec. 31, 2003 (TW) 092137859

(51) Int. Cl. G06F 9/44

(52) U.S. Cl. 717/168

(57) ABSTRACT

A firmware updating method, implemented in a server and a client computer. The client computer comprises an application and at least a peripheral device comprising a first firmware program and identification information. The server stores at least a second firmware program. An auto-execution program is initiated through a shortcut on a menu of the application. The auto-execution program directs the client computer to automatically connect to the server, determine the identification information of the peripheral device, determine whether the second firmware version is newer than the first firmware version, display a list indicating the second firmware program if the second firmware version is newer than the first firmware version, download the second firmware program from the server to the client computer when the second firmware program is selected, and replace the first firmware program with the second firmware program.

### BACKGROUND

The invention relates to a peripheral device, and in particular to a method and an application for updating the firmware of the peripheral device.

Firmware is typically included in disc drives. Firmware directs a disc drive and provides information for identifying the quality of various discs, on which the preferred access speed thereof depends. After identifying a disc, a disc drive can accordingly read or write the identified disc at a preferred speed. When attempting to read or write to a disc which cannot be identified, a disc drive adopts a lower speed to prevent errors from occurring.

Due to the multitude of disc products, disc drive firmware programs must be frequently updated.

Typically, without a dedicated tool for updating the firmware of a disc drive, a user must search the manufacturers website to locate new firmware. After locating the new firmware, the program must be downloaded, decompressed and installed. This process is inconvenient for a user.

Although disc drive firmware must be updated frequently, the frequency is lower than for virus definitions required by antivirus software. Because required frequently, virus definition updates are typically triggered automatically by a memory-resident program stored in a random access memory. Memory-resident programs, however, consume memory capacity and system resource. It is inefficient to update firmware program using a memory-resident program.

Hence, there is a need for firmware update method to ameliorate the above-described disadvantages.

### SUMMARY

Accordingly, an embodiment of the invention provides a firmware update method, implemented in a server and a client computer. The client computer comprises an application and at least a peripheral device comprising a first firmware program and identification information. The server stores at least a second firmware program. An auto-execution program is initiated through a “shortcut” in a menu of the application. The auto-execution program directs the client computer to automatically connect to the server, identify the identification information of the peripheral device, determine whether the second firmware version is newer than the first firmware version, display a list indicating the second firmware program if the second firmware version is newer than the first firmware version, download the second firmware program from the server to the client computer when the second firmware program is selected, and replace the first firmware program with the second firmware program.

Additionally, an embodiment of the invention provides an application, implemented in a computer comprising at least a peripheral device which comprises identification information and a first firmware. The application comprises a first menu and a second menu. The application switches between the first menu and the second menu and displays the first menu or the second menu based on the identification information.

An embodiment of the invention further provides a firmware updating method, implemented in a computer which comprises at least a peripheral device comprising a first firmware program. First, the computer is connected to a server. Next, a user interface for initiating an auto-execution program is displayed. The auto-execution program is initiated and directs the computer to determine whether any firmware program suitable for the peripheral device and newer than the first firmware is stored on the server. If so, a list of new firmware programs for the peripheral device is displayed.

Additionally, the firmware updating method of an embodiment of the invention can be implemented with a computer application recorded in a storage medium such as a memory or a memory device. The computer application, when loaded into a computer, directs the computer to execute the firmware updating method of the invention.

### DESCRIPTION OF THE DRAWINGS

An embodiment of the invention can be more fully understood by reading the subsequent detailed description and examples with references made to the accompanying drawings, wherein:

FIG. 1 is a block diagram of a network system of an embodiment of the invention;

FIG. 2 is a schematic diagram of a terminal of an embodiment of the invention;

FIG. 3 is an example of a portion of the index file content in the invention;

FIG. 4A and 4B comprise a flow chart of the firmware updating method of an embodiment of the invention;

FIG. 5 is a first menu of an embodiment of the invention;

FIG. 6 is the device list of an embodiment of the invention;

FIG. 7 is a firmware list of an embodiment of the invention; and

FIG. 8 is a schematic diagram of the storage medium of an embodiment of the invention.

### DETAILED DESCRIPTION

Embodiments of the invention provide a firmware updating method for ameliorating with enhanced convenience and efficiency for a peripheral device.

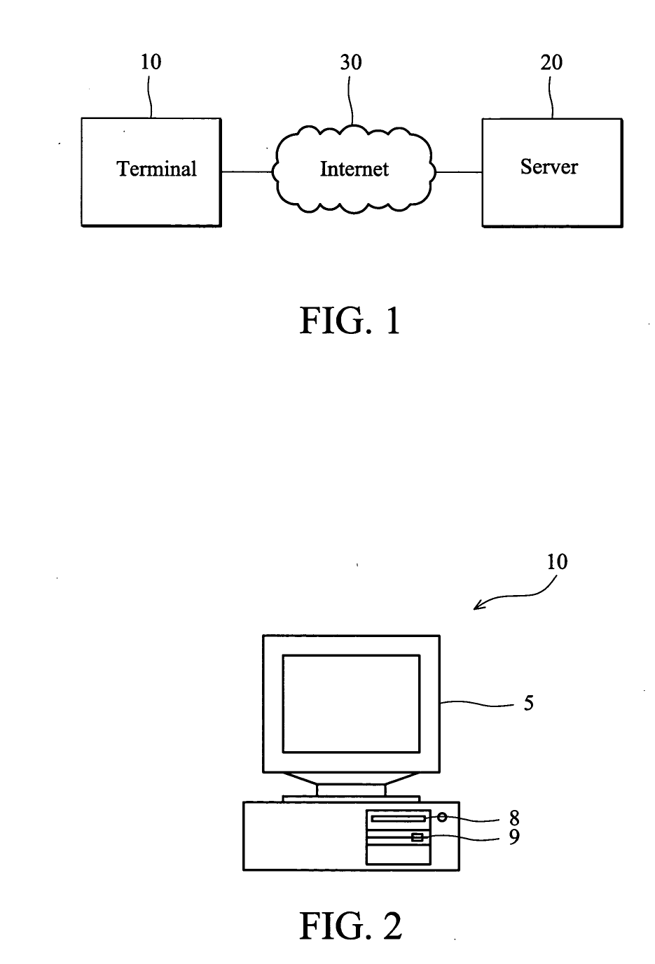

FIG. 1 is a block diagram of the network system of an embodiment of the invention. The network system comprises terminal 10, server 20 and Internet 30. In the invention, terminal 10 comprises a computer. Terminal 10 connects to server 20 through Internet 30. Note that the arrangement is not intended to limit the invention. Terminal 10 may connect to server 20 using other methods, such as a local area network (LAN) or wireless LAN.

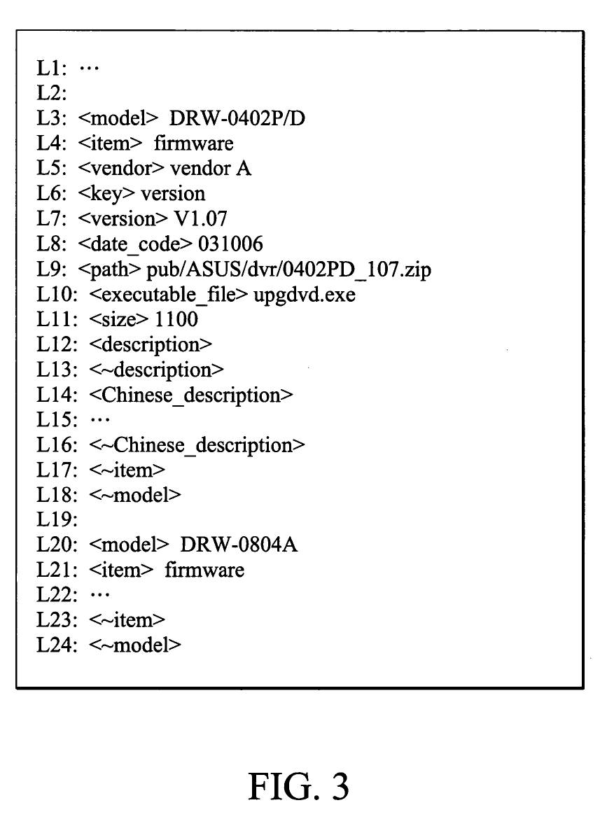

FIG. 2 is a schematic diagram of a terminal of an embodiment of the invention. Terminal 10 is provided with a display 5 and a plurality of peripheral devices, such as disc drive 8 and 9, each comprising respective identification information. In the invention, terminal 10 further comprises an operating system (not shown) driving terminal 10 and a plurality of applications (not shown) executable for terminal 10.

In an embodiment of the invention, server 20 stores an index file and a plurality of firmware programs some of which are suitable for disc drives 8 and 9. The index file and firmware programs, however, may be stored on different servers respectively.

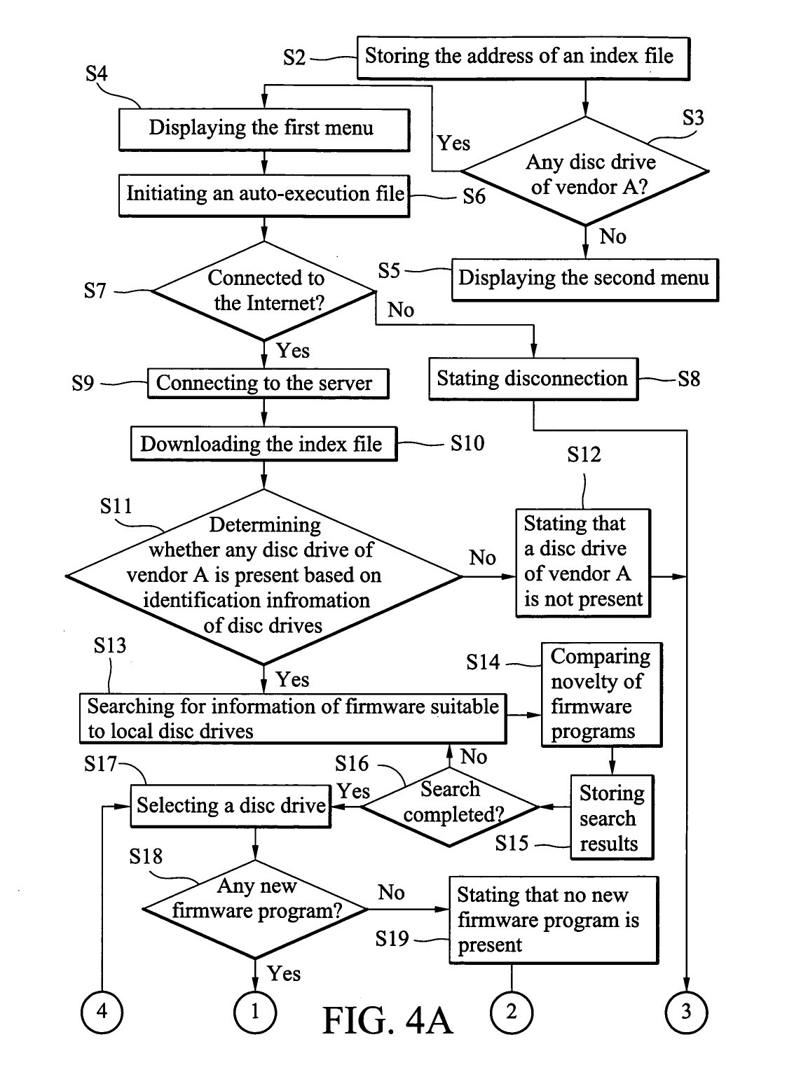

FIG. 3 is an example of a portion of the index file content. The index file is a list of firmware programs stored on server 20, recording information of firmware programs, comprising file names and paths (as shown in L9), model name of suitable device (as shown in L3), version code (as shown in L7) and date code (as shown in L8).

The index file may record other information, such as vendor ID of suitable devices (as shown in L5), key word for novelty comparison (as shown in L6), decompressed file names of firmware programs (as shown in L10), size of firmware programs (as shown in L11), description of firmware programs (as shown in L12 to L16). The aforementioned information is not intended to limit the invention. In the description, the novelty comparison is a process of comparing firmware program version, i.e. to determine which firmware program is newer.

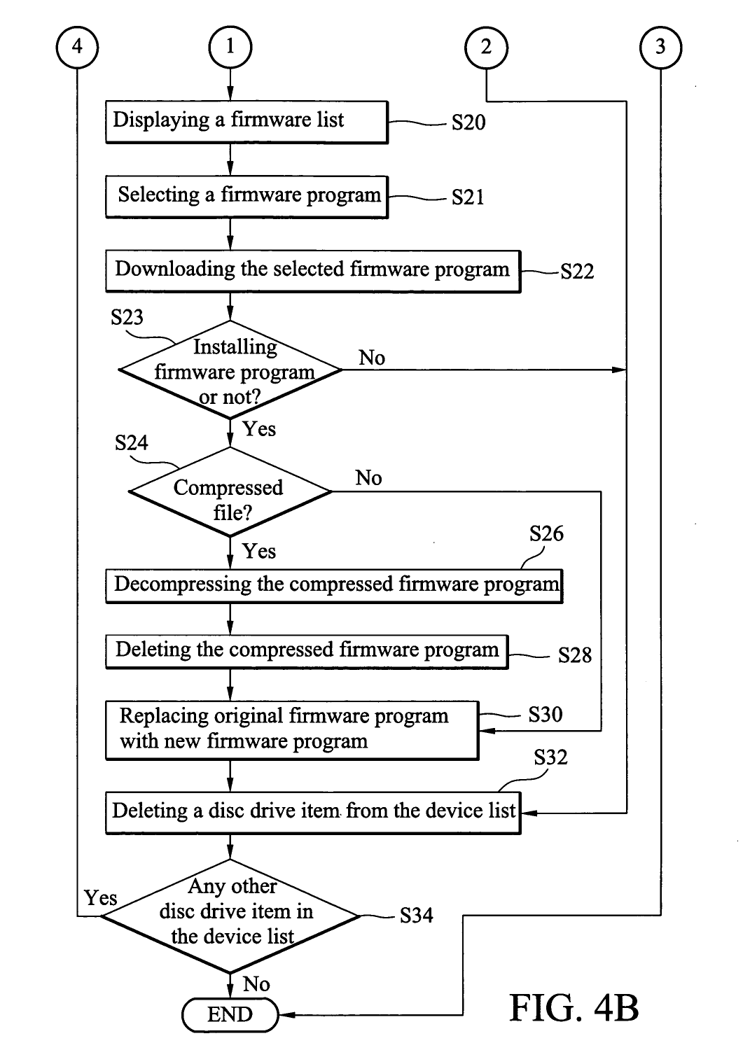

FIG. 4A and 4B comprise a flow chart of the firmware updating method of the invention. First, an address of the index file is recorded in terminal 10 (step S2), wherein the address comprises the address of server 20 and path of the index file.

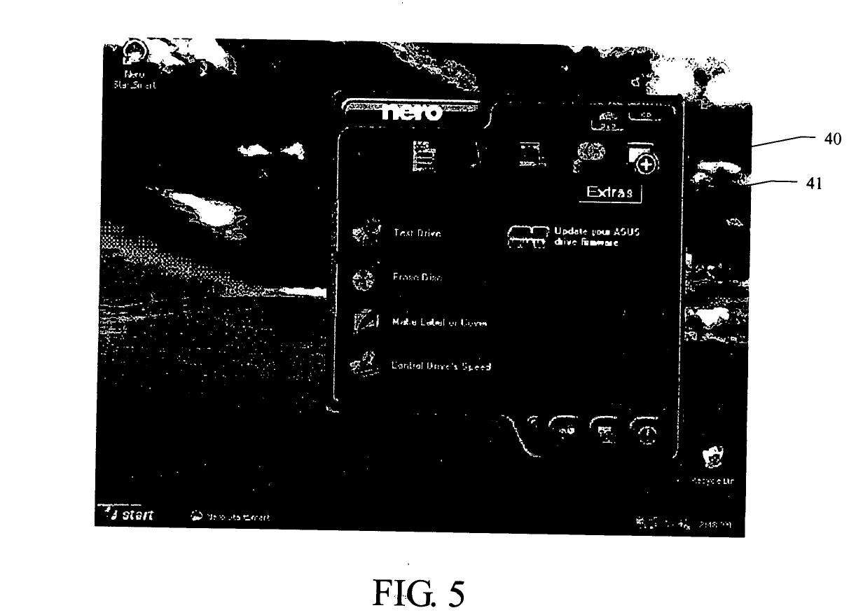

An application, such as disc recording program or disc playing program, executed in terminal 10 comprises a first menu (as shown in FIG. 5) and a second menu (not shown). When executed, the application directs terminal 10 to identify whether any peripheral device, such as a disc drive, of a specific vendor (such as vendor A) exists in terminal 10 (step S3).

In an embodiment of the invention, using the model name of a disc drive as identification information, terminal 10 determines whether any disc drive of vendor A exists therein and displays the first menu or the second menu accordingly. In the embodiment, a model name comprises a vendor ID. Terminal 10 displays the first menu when at least a disc drive of vendor A exists in terminal 10 (step S4).

User interface, such as a shortcut icon, for triggering an auto-executable program is included in the first menu, wherein the auto-executable program is responsible for updating firmware of a disc drive of a specific vendor (such as vendor A).

When no disc drive of vendor A exists in terminal 10, the second menu is displayed (step S5), which excludes the user interface. In other words, disc drive of a vendor rather other than vendor A cannot use the auto-executable program to update firmware thereof.

The auto-execution program may automatically detect disc drives of a specific vendor (such as vendor A) or may be notified by the OS. In this description, when step S3 is performed by detection, step S3 is hereafter referred as a first detection step.

Next, as shown in FIG. 5, a first menu 40 comprising a button 41 for triggering the auto-executable program is displayed on display 5 (step S4).

The following description is given with reference to FIG. 4A, 4B and 5. When button 41 is pressed according to user operation, the auto-executable program is initiated (step S6 in FIG. 4A). The auto-executable program directs terminal 10 to perform the following steps. First, it is determined whether terminal 10 is connected to Internet 30 (step S7 in FIG. 4A).

When terminal 10 is not connected to Internet 30, a disconnected message is presented on display 5 (step S8 in FIG. 4A), and the firmware updating procedure is complete.

If terminal 10 is connected to Internet 30, terminal 10 connects to server 20 according to the address thereof (step S9) and downloads the index file according to the path thereof (step S10). In the description, disc drive identification information (such as model names or serial numbers) comprises vendor ID. Terminal 10 determines whether any disc drive of vendor A exists based on the disc drive identification information (step S11). The arrangement wherein step S11 follows step S10, however, is not intended to limit the invention. When no vendor A disc drive is identified, a message stating that a vendor A disc drive is not present is presented on display 5 (step S12), and firmware updating procedure is complete. Step S11 may be combined with the first detection step. Under this condition, step S11 may be omitted, and step S13 follows step S10.

The application interface of the OS may be used to acquire and detect identification information of peripheral devices (such as disc drive) of terminal 10. For example, the auto-executable program asks the OS to return identification information of terminal 10. This arrangement, however, is not intended to limit the invention.

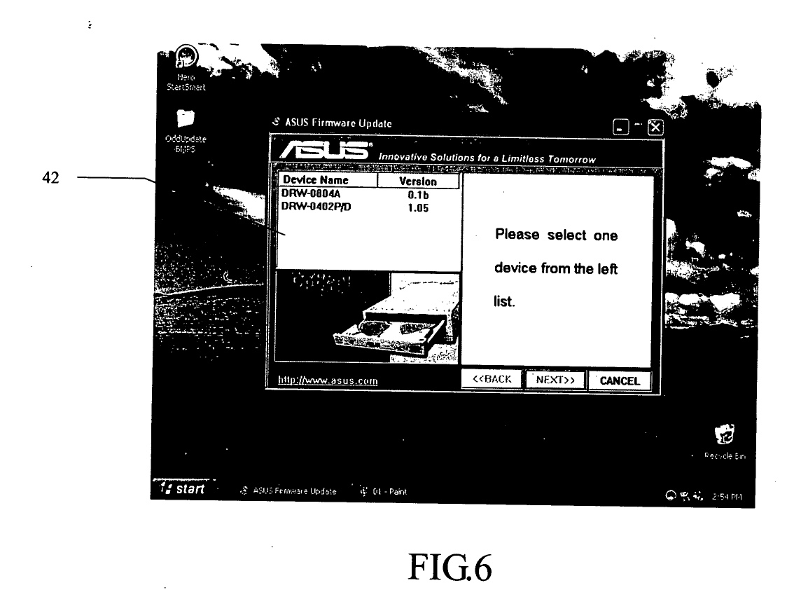

When at least a disc drive of vendor A is identified, terminal 10 acquires identification information thereof, comprising vendor ID and identification information of the present firmware program, wherein the identification information of the present firmware program comprises a version code and a date code. In an embodiment of the invention, for example, terminal 10 determines disc drives 8 and 9 to belong to vendor A. Next, identification information of disc drives 8 and 9 is listed in a device list 42, as shown in FIG. 6

FIG. 6 is the device list of an embodiment of the invention. The identification information and version of disc drive 8 are “DRW-0804A” and “0.1b” respectively. The identification information and version of disc drive 9 are “DRW-0402P/D” and “1.05” respectively.

Terminal 10 searches the index file for information (such as <model>, <path>, <version>, <date_code>, <size> fields and other information in FIG. 3) related to firmware programs suitable for local disc drive 8 and 9 based on the acquired identification information, date code and version code (step S13). A firmware program is suitable to a disc drive when content of “<model>” field of the information related to the firmware in the index file is the same as the model name of the disc drive, and the content of “<date_code>” or “<version>” thereof is newer than date code or version code of the present firmware program of the disc drive. During the search process, terminal 10 compares novelty of firmware programs based on date code or version code (step S14). Search results extracted from the index file are then recorded and sorted according to local disc drives (step S15). For example, terminal 10 stores information related to disc drive 9, i.e. L3 to L8, in a memory of terminal 10.

The date code or version code may be adopted as a key word for novelty comparison. An index, such as “<key> version” in L6 of FIG. 3, can be recorded as a key word for comparison in the index file according to each firmware program.

With reference to FIG. 4A, terminal 10 determines if a search is complete (step S16). If so, terminal 10 proceeds to step S17. If not, terminal 10 returns to step S13.

When a disc drive, such as disc drive 9, is selected according to user choice (step S17), terminal 10 determines whether any new firmware program exists in the search result corresponding to the selected disc drive (step S18). When no new firmware program exists in the corresponding search result, terminal 10 displays a message stating that no new firmware program is present (step S19). Next, terminal 10 proceeds to step S32 to delete disc drive 9 from the device list 42.

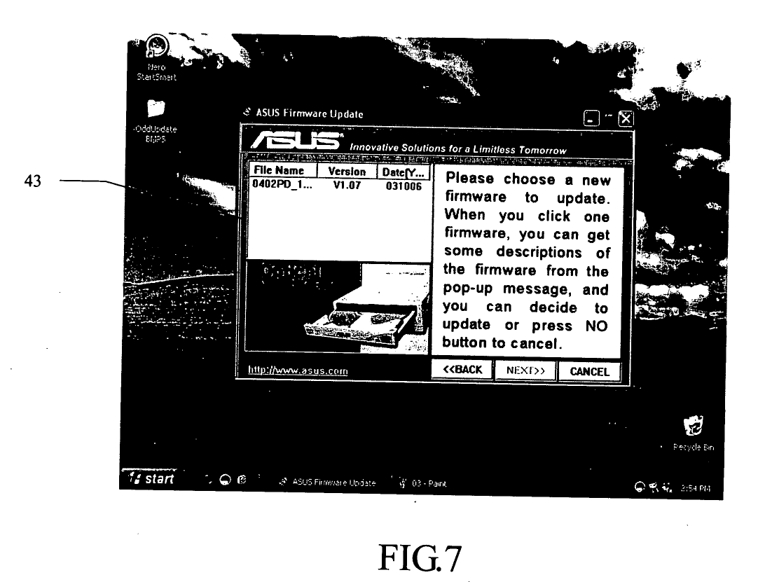

When at least a new firmware program exists in the corresponding search result, terminal 10 displays a firmware list 43, as shown in FIG. 7 (step S20). Firmware list 43 displays file name, version (version code) and release date (date code) of new firmware program.

FIG. 7 is a firmware list of an embodiment of the invention. Firmware list 43 indicates a new firmware program stored in server 20, file name, version and date code of which are “0402PD_{—}107.zip”, “V1.07” and “031006” respectively.

When a firmware program is selected according to user choice (step S21), terminal 10 displays a request message to request permission from a user to download the selected firmware program.

When the user gives permission, terminal 10 acquires the address and path of the selected firmware program from the corresponding search result and downloads the selected firmware program accordingly (step S22).

After the download is complete, terminal 10 displays a message to request the user to install the downloaded firmware program (step S23). If the requested installation is cancelled, terminal 10 proceeds to step S32 to delete disc drive 9 from the device list. When the user permits the requested installation, then terminal 10 determines whether the downloaded firmware program comprises a compressed file (step S24).

If the downloaded firmware program comprises an executable file rather than a compressed file, then terminal 10 proceeds to step S30 to install the downloaded firmware program directly. If the downloaded firmware program is a compressed file, terminal 10 then decompresses the downloaded compressed file and generates decompressed file thereof (step S26). Terminal 10 deletes the compressed file (step S28) and installs the decompressed firmware program to replace the original firmware program of disc drive 9 (step S30). In the installation step, the original firmware program is replaced with the downloaded firmware program.

When finishing installation, terminal 10 proceeds to step S32 to delete disc drive 9 from the device list (step S32). Next, terminal 10 determines whether any disc drive exists in the device list (step S34). When at least a device exists in the device list, terminal 10 returns to step S17. When no device exists in the device list, the firmware updating process is complete.

The firmware updating method may be implemented in other peripheral devices, such as floppy disk drives, magneto-optical disk drives or storage devices capable of reading compact disc read-only memory (CD-ROM), digital versatile discs/disks (DVD), phase change dual disks (PD), MiniDisc, integrated circuit (IC) cards or Miniature card.

A storage medium storing a computer program for implementing the firmware updating method of the invention is also provided.

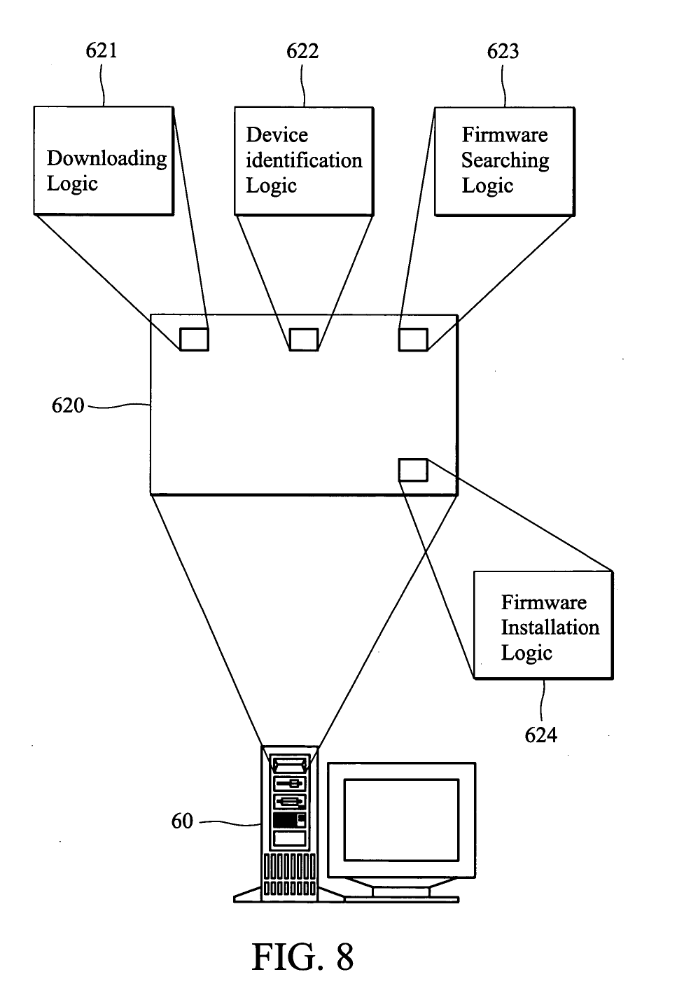

FIG. 8 is a schematic diagram of the storage medium of the invention. Storage medium 60 stores a computer program 620 for implementing the firmware updating method of the invention. The computer program 620 comprises downloading logic 621, device identification logic 622, firmware searching logic 623 and firmware installation logic 624.

Downloading logic 621 is responsible for downloading the index file and firmware programs. Device identification information logic 622 is responsible for identifying peripheral devices of a specific vendor. Firmware searching logic 623 is responsible for locating firmware program information suitable for local peripheral devices. Firmware installation logic 624 is responsible for decompressing and installing firmware programs.

Button 41 can be included in other applications, such as a DVD player application or disc recording application. When an application as described above is executed, the application directs the terminal 10 to determine whether any device of vendor A is provided therein. If so, button 41 is presented on display 5.

Button 41 may be a stand-alone graphical user interface excluded from any other application, such as a shortcut icon on a desktop of the user interface of the OS.

In the above embodiments, messages are displayed to state the progress of a firmware updating process or request a decision from a user for determining whether to initiate a firmware updating process, download, decompression and installation of firmware. The process of initiating firmware updating process, downloading, decompression or installation firmware, however, can also be automatically performed without notifying the user.

Identification information of peripheral devices is acquired using positive detection and adopted as a key to search for suitable firmware programs. Other methods, however, may be used. For example, in a case of a firmware-updating program dedicated to a device, the dedicated program may preserve the address of only a new firmware. The new firmware is downloaded according the address thereof. Acquisition of device identification information is, thus, omitted.

In the above description, the index file and a plurality of firmware programs are stored on the same server. The index file and the firmware programs, however, may be stored on different servers. For example, the index file is stored on a first server, and the firmware programs are stored on a second server. In this case, the address of the second server and the path of the firmware programs are recorded in the index file.

Hence, the firmware updating method of embodiments of the invention enhances convenience and efficiency.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A firmware updating method, implemented in a server and a client computer comprising an application and at least a peripheral device comprising a first firmware program and identification information, wherein the server stores at least a second firmware program, comprising the steps of:
initiating an auto-execution program through a shortcut user interface on a menu of the application, wherein the auto-execution program directs the client computer to execute the steps of:
connecting the client computer to the server;
identifying the identification information of the peripheral device;
determining whether the second firmware version is newer than the first firmware version;
displaying a list indicating the second firmware program if the second firmware version is newer than the first firmware version;
downloading the second firmware program from the server to the client computer when the second firmware program is selected; and
replacing the first firmware program with the second firmware program.

2. The method as claimed in claim 1, wherein the application comprises a disc recording program.

3. The method as claimed in claim 1, wherein the peripheral device comprises a disc drive.

4. The method as claimed in claim 1, wherein the identification information comprises vendor ID.

5. The method as claimed in claim 1, wherein the first firmware program comprises a first date code, the second firmware program comprises a second date code, and the determination step further comprises the step of comparing the first date code and the second date code.

6. The method as claimed in claim 1, wherein the first firmware program comprises a first version code, the second firmware program comprises a second version code, and the determination step further comprises the step of comparing the first version code and the second version code.

7. An application, implemented in a computer comprising at least a peripheral device comprising an identification information, comprising:
a first menu; and
a second menu;
wherein the application switches between the first menu and the second menu and displays the first menu or the second menu based on the identification information.

8. The application as claimed in claim 7, wherein the first menu provides a user interface for initiating a firmware updating program.

9. The application as claimed in claim 8, wherein the peripheral device comprises a first firmware program, and the firmware updating program executes the steps of:
connecting the computer to a server comprising a second firmware program;
identifying the identification information of the peripheral device;
determining whether the second firmware version is newer than the first firmware version;
displaying a list indicating the second firmware program when the second firmware version is newer than the first firmware version;
downloading the second firmware program to the computer when the second firmware program is selected; and
replacing the first firmware program with the second firmware program.

10. The application as claimed in claim 9, wherein the determination step further comprises the step of comparing a first date code of the first firmware program and a second date code of the second firmware program.

11. The application as claimed in claim 9, wherein the determination step further comprises the step of comparing a first version code of the first firmware program and a second version code of the second firmware program.

12. The application as claimed in claim 7, wherein the application comprises a disc recording program.

13. The application as claimed in claim 7, wherein the peripheral device comprises a disc drive.

14. A firmware updating method, implemented in a computer comprising at least a peripheral device comprising a first firmware program, comprising the steps of:
connecting the computer to a server;
displaying an interface for initiating an auto- execution program;
when the auto-execution program is initiated, executing the steps of:
determining whether the server comprises any firmware program suitable for the peripheral device and version of which is newer than the first firmware version; and
displaying a list indicating a new firmware program suitable for the peripheral device when the server comprises the new firmware program with newer version than the first firmware version.

15. The method as claimed in claim 14, wherein the peripheral device comprises a disc drive.

16. The method as claimed in claim 14, further comprising the step of acquiring identification information of the peripheral device, on which the determining step of claim 14 depends.

17. The method as claimed in claim 16, wherein the list is displayed based on the identification information.

18. The method as claimed in claim 16, wherein before the displaying step the method further comprises the steps of:
downloading an index file comprising information related to at least a second firmware program stored on the server and the identification information of the peripheral device; and
searching the index file for information related to any firmware program corresponding to the identification information of the peripheral device required by the determining step of claim 14, wherein the list comprises the search result.

19. The method as claimed in claim 18, wherein the index file comprises at least version code or date code, and the searching step further comprises the step of searching the index file for information, as the content of the list, of any firmware program suitable for the peripheral device and version of which is newer than the first firmware version based on the version code or date code.

20. The method as claimed in claim 18, after the displaying step, further comprising the steps of:
acquiring an address, recorded in the index file, of the new firmware program indicated by the list; and
downloading the new firmware program from a second server to the computer based on the acquired address of the new firmware program.
